(19) United States
(12) Patent Application Publication
(10) Pub. No.: US 2026/0178166 A1
(43) Pub. Date: Jun. 25, 2026

(54) INFORMATION PROCESSING DEVICE AND DISPLAY CONTROL METHOD

(71) Applicant: Faurecia Clarion Electronics Co., Ltd., Saitama-shi (JP)

(72) Inventor: Takuma SHIOGUCHI, Saitama (JP)

(21) Appl. No.: 19/428,937

(22) Filed: Dec. 22, 2025

(30) Foreign Application Priority Data
Dec. 24, 2024 (JP) 2024-227752

(51) Int. Cl. G06F 3/0482; G06F 3/0485; G06F 3/0488; G06F 3/14

(52) U.S. Cl. CPC G06F 3/0482; G06F 3/0485; G06F 3/0488; G06F 3/1454

(57) ABSTRACT

An information processing device for controlling contents displayed on a plurality of display devices and being configured to: acquire, when a first gesture on a touch panel is detected, a plurality of captured images of the contents, display a selection screen for displaying the plurality of captured images around a figure displayed at a position including a start point of the first gesture; determine, based on a second gesture, a second image to be displayed from the plurality of captured images; select one of a first mode for displaying the second image on the touch panel and a second mode for displaying the second image in a window on the touch panel, and display the second image in the selected mode; and transmit, when a third gesture on the second image is detected, an operation command based on the third gesture to a display device.

### CROSS REFERENCE TO RELATED APPLICATION

This patent application claims the benefit and priority of Japanese Patent Application No. 2024-227752, filed on Dec. 24, 2024, the disclosure of which is incorporated by reference herein in its entirety as part of the present application.

### FIELD

The present invention generally relates to an information processing device and a display control method.

### BACKGROUND

Conventionally, there is a technique for transferring an image from a certain device to a different device and displaying the image on the difference device. Patent Document 1 (WO2013/111239) has the following description: “Provided is a mobile terminal that can issue an instruction for device linkage, without special hardware being mounted in the mobile terminal and by means of a simple operation. The mobile terminal is a mobile terminal (10) that is connected to a TV (20) by a communication unit, and is provided with: a communication interface unit (14) for communicating with the TV (20); a storage unit (15) that retains content to be displayed on the TV (20); a display unit (13) that has a touchpad (13a) and a display screen (13b); and a control unit (12) that displays, on the display screen (13b), a content icon which is an icon associated with the content. When the control unit (12) detects that the content icon has been flicked after being pressed for a long time in the display unit (13), the control unit (12), in order for the content to be displayed on the TV (20), reads the content from the storage unit (15) and transfers the content to the TV (20) via the communication interface unit (14).”

### SUMMARY

The conventional technique does not assume a case where there are a plurality of source devices that are providers of images. When there are a plurality of source devices, improved operability related to the selection of a source device is demanded on the side of a sync device for displaying provided images. In particular, when an image is transferred between devices mounted on a vehicle, implementing an intuitive and simple operation is important.

The present application aims to improve the operability of a sync device to which a plurality of source devices are connected.

In order to achieve the above-mentioned object, one of the representative information processing devices of the present application is an information processing device capable of controlling a contents being displayed on a plurality of display devices. The information processing device is characterized by comprising: a touch panel; a gesture detection unit configured to detect a gesture on the touch panel; a communication unit configured to communicate with the plurality of display devices; a selection screen display unit configured to acquire, when a first gesture is detected, a plurality of captured images of the contents, and to display, on the touch panel, a selection screen for displaying the plurality of captured images around a figure displayed at a position including a start point of the first gesture; a display control unit configured to determine, based on a second gesture, a second image to be displayed on the touch panel from among the plurality of captured images, to select any mode of a first mode for displaying the second image on the touch panel in full screen and a second mode for displaying the second image in a window displayed on the touch panel, and to display the second image in the selected mode; and a transmission unit configured to transmit, when a third gesture on the second image is detected, an operation command based on the third gesture to a display device of a capture destination.

According to the present application, improved operability can be provided for a sync device to which a plurality of source devices are connected.

### DRAWINGS

FIG. 1 is a configuration diagram of a system;

FIG. 2 is a diagram illustrating an arrangement of devices in a vehicle;

FIG. 3 is a first series of drawings for explaining a transition of display;

FIG. 4 is a second series of drawings for explaining a transition of display;

FIG. 5 is a flowchart of an information processing device;

FIG. 6 is a first modification of the display;

FIG. 7 is a second modification of the display; and

FIG. 8 is a third modification of the display.

### DETAILED DESCRIPTION OF EMBODIMENTS

Next, an embodiment of the present application will be described using drawings.

### Embodiment 1

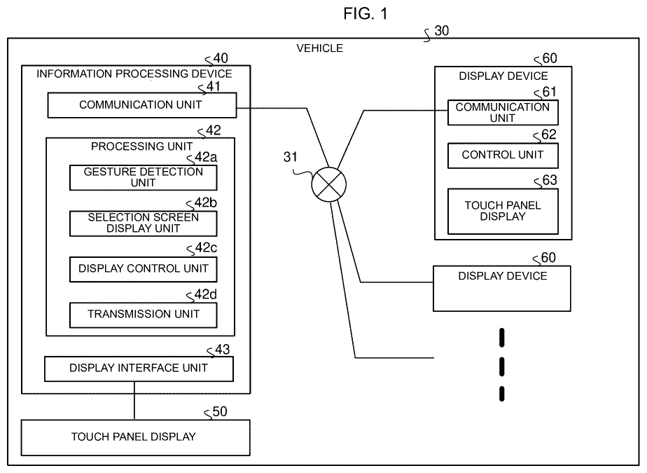

FIG. 1 is a configuration diagram of a system of the present embodiment. The vehicle 30 is equipped with an information processing device 40, a touch panel display 50, and a plurality of display devices 60. The information processing device 40 is installed, for example, at the center of the dashboard and between the driver's seat and the passenger seat. The information processing device 40 is connected to a touch panel display 50 that is visible to the occupants in the driver seat and the front passenger seat. An alternative configuration may have the information processing device 40 including the touch panel display 50. The information processing device 40 can display map information and/or route information. The information processing device 40 can receive images transferred from the plurality of display devices 60 and display the transferred images on the touch panel display 50.

The display device 60 includes a touch panel display 63 that is visible to the occupant/occupants in the rear seats. For example, the display device 60 may be installed on the ceiling of the vehicle cabin, or may be installed on the backrest of a front seat. The display device 60 is capable of communicating with the information processing device 40 via the network 31 of the vehicle.

The display device 60 has a communication unit 61, a control unit 62, and a touch panel display 63. The communication unit 61 communicates with the information processing device 40 via a network 31. The control unit 62 performs display control on the touch panel display 63 and processing of an operation received by the touch panel display 63. In addition, the display device 60 may include any wired or wireless interface. The control unit 62 can display content acquired via any interface. The display device 60 can transmit image data to the information processing device 40 via the communication unit 61. The display device 60 receives an operation command from the information processing device 40 via the communication unit 61. The display device 60 can process the operation command received from the information processing device 40 in the same manner as the operation received by the touch panel display 63.

The information processing device 40 includes a communication unit 41, a processing unit 42, and a display interface unit 43. The communication unit 41 communicates with the display device 60 via the network 31. The processing unit 42 is, for example, a processor and a memory, and realizes various functions by executing a predetermined program. In the present embodiment, the processing unit 42 realizes functions as a gesture detection unit 42a, a selection screen display unit 42b, a display control unit 42c, and a transmission unit 42d. The display interface unit 43 communicates with the touch panel display 50. The processing unit 42 transmits screen data to the touch panel display 50 via the display interface unit 43, and receives operation data from the touch panel display 50.

The gesture detection unit 42a detects a gesture on the touch panel display 50. The detected gestures include a first gesture, a second gesture, and a third gesture. The first gesture is an operation of starting a slide operation from a predetermined corner of the touch panel display 50. The second gesture is an operation in which the slide operation started by the first gesture is ended and the finger of the operator is separated from the touch panel display 50. The third gesture is an operation on image data provided from the display device 60 and displayed on the touch panel display 50.

When the first gesture is detected, the selection screen display unit 42b acquires the captured images of the contents from the plurality of display devices 60. The selection screen display unit 42b displays a fan-shaped figure including a start point of the first gesture, and displays the plurality of captured images around the figure. A screen on which a plurality of captured images are displayed around a fan-shaped figure is a selection screen for selecting a captured image. When a gesture of sliding along an arc of the fan shape is detected, the selection screen display unit 42b moves the plurality of captured images displayed around the fan shape.

The display control unit 42c determines, based on the second gesture, a second image to be displayed on the touch panel display 50 from among the plurality of captured images. The display control unit 42c selects either a first mode or a second mode when displaying the second image on the touch panel display 50. The first mode is a mode in which the second image is displayed on the entire screen of the touch panel display 50. The second mode is a mode in which a window is displayed on the touch panel display 50 and the second image is displayed in the window.

When the second gesture is detected outside the fan-shaped figure, the display control unit 42c determines the captured image displayed at a predetermined position as the second image. The display control unit 42c selects the second mode when the amount of movement of the second gesture is less than a first amount of movement, whereas the display control unit 42c selects the first mode when the amount of movement of the second gesture is equal to or greater than the first amount of movement. Which captured image is displayed at the predetermined position can be changed by moving the captured images by a gesture of sliding along the arc of the fan shape.

When the third gesture on the second image is detected, the transmission unit 42d transmits an operation command based on the third gesture to the display device 60 of the capture destination. The capture destination is a provider of the captured image, that is, the display device 60 serving as a source device. The information processing device 40 is a sync device that displays, as a second image, a captured image acquired from the display device 60. The information processing device 40 can control, by transmitting an operation command, the content being displayed on the display device 60.

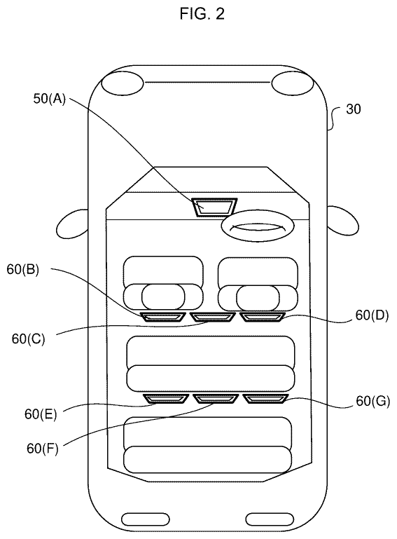

FIG. 2 is a diagram illustrating an arrangement of devices in a vehicle. In the vehicle 30, the touch panel display 50 is installed at the center of the dashboard and between the driver's seat and the passenger seat. The vehicle 30 has two rows of rear seats, and three display devices 60 are arranged in each row. In FIG. 2, the touch panel display 50 displays an image of a content A. The display device 60 on the left side of the first row of the rear seats displays an image of a content B. The display device 60 at the center of the first row of the rear seats displays an image of a content C. The display device 60 on the right side of the first row of the rear seats displays an image of a content B. The display device 60 on the left side of the second row of the rear seats displays an image of a content E. The display device 60 at the center of the second row of the rear seats displays the image of a content F. The display device 60 on the right side of the second row of the rear seats displays an image of a content G.

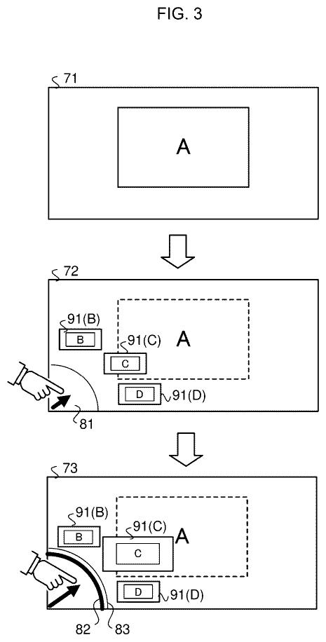

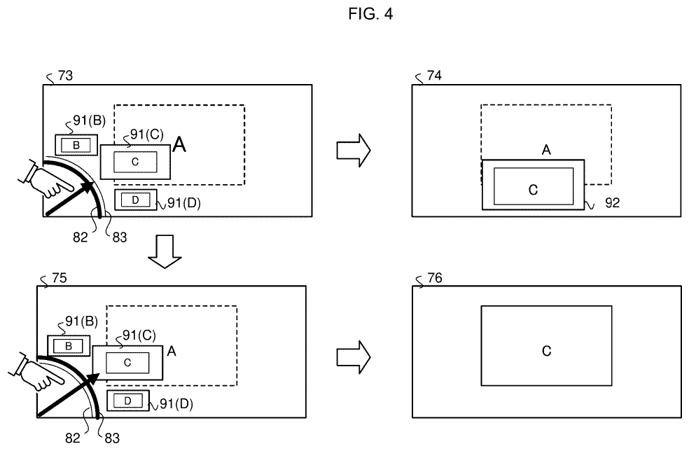

FIGS. 3 and 4 are two series of drawings each of which explains a transition of display. Screens 71 to 76 in FIGS. 3 and 4 are screen examples of the touch panel display 50. The content A is displayed on the screen 71.

When a slide operation is performed from the lower left corner of the touch panel display 50, the screen transitions to a screen 72, which is a selection screen. In the screen 72, the content A is grayed out, and a fan-shaped FIG. 81 including the lower left corner is displayed. A plurality of captured images 91 are displayed around the FIG. 81. The plurality of captured images 91 are captured images of the contents acquired from the plurality of display devices 60. On the screen 72, a captured image 91(B) of the content B, a captured image 91(C) of the content C, and a captured image 91(D) of the content D are displayed. When a gesture of sliding along the arc of the FIG. 81 is detected, the captured images are moved. For example, with a counterclockwise-direction slide, the captured images 91 move in the counterclockwise direction. By this movement, the captured image 91(B) disappears from the screen, and the captured image 91(E) appears next to the captured image 91(D). With a clockwise-direction slide, the captured images 91 move in the clockwise direction. By this movement, the captured image 91(D) disappears from the screen, and the captured image 91(G) appears in front of the captured image 91(B).

In this manner, the operator can manipulate the display positions of the captured images 91(B) to 91(G) on the screen 72. Then, the captured image located at a predetermined position on the screen 72 will be a candidate for the second image.

When the slide operation proceeds in the radial direction of the FIG. 81, the screen transitions to the screen 73. On the screen 73, the diameter of the FIG. 81 is increased, and an arc 82 and an arc 83 are displayed. The outer arc 83 corresponds to the first mode in which the second image is displayed on the full screen. The inner arc 82 corresponds to the second mode in which the second image is displayed in a window on the screen. In addition, the captured image that is the candidate for the second image is displayed in an increased size to indicate which captured image is the candidate for the second image. In FIG. 3, the captured image 91(C) is the candidate for the second image.

When the amount of movement of the slide operation is less than a first threshold value and equal to or greater than a second threshold value, the inner arc 82 emits light. In this state, the operator's releasing the finger determines the second image to be displayed in the second mode as shown in a screen 74. In FIG. 4, a window 92 appears, and a captured image 91(C) is displayed in the window 92.

When the amount of movement of the slide operation becomes equal to or greater than the first threshold value, the outer arc 83 emits light as illustrated in a screen 75. In this state, the operator's releasing the finger determines the second image to be displayed in the second mode as shown in a screen 76. In FIG. 4, the captured image 91(C) is displayed in full screen.

Both in the first mode and in the second mode, the information processing device 40 can receive an operation on the second image. The received operation is transmitted as an operation command to the display device 60 that is the provider of the second image. Therefore, the operator can select any display device 60 in the vehicle by operating the touch panel display 50 and thus can operate the selected display device 60.

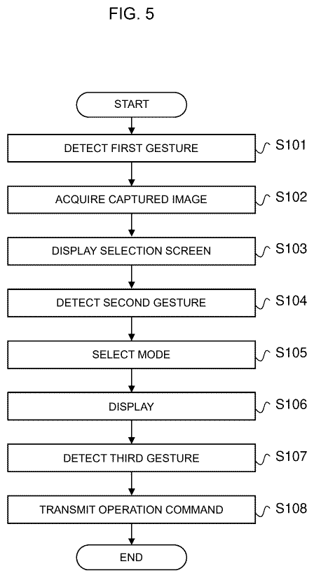

FIG. 5 is a flowchart showing the processing operation of the information processing device 40. The information processing device 40 sequentially executes the following steps S101 to S108.

At Step S101, the gesture detection unit 42a detects the first gesture. Thereafter, the process proceeds to Step S102.

At Step S102, the selection screen display unit 42b acquires captured images of contents from the plurality of display devices 60. Thereafter, the process proceeds to Step S103.

At Step S103, the selection screen display unit 42b displays a selection screen using captured images acquired from the plurality of display devices 60. Thereafter, the process proceeds to Step S104.

At Step S104, the gesture detection unit 42a detects the second gesture. Thereafter, the process proceeds to Step S105.

At Step S105, the display control unit 42c determines the second image based on the second gesture, and selects one of the first mode and the second mode. Thereafter, the process proceeds to Step S106.

At Step S106, the display control unit 42c displays the second image in the selected mode. Thereafter, the process proceeds to Step S107.

At Step S107, the gesture detection unit 42a detects the third gesture. Thereafter, the process proceeds to step S108.

At Step S108, the transmission unit 42d transmits an operation command based on the third gesture to the display device 60 of the capture destination. Thereafter, the process is terminated.

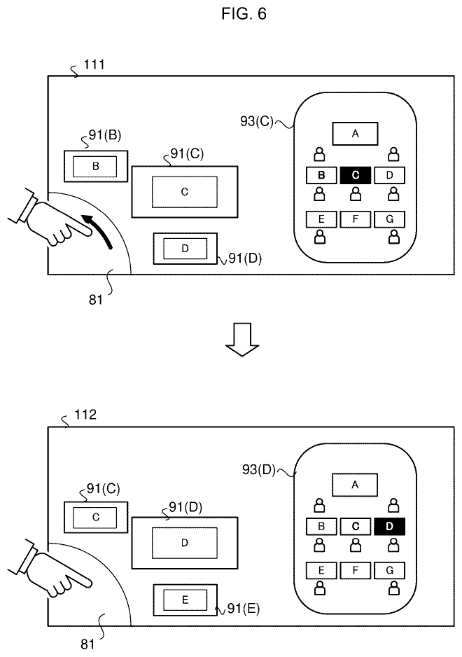

FIGS. 6 to 8 illustrate display modifications. In FIG. 6, the selection screen is displayed with a captured image that is a candidate for the second image and a seat image 93 that schematically indicates a positional relationships of the seats. The screen 111 is a screen in which a seating image 93 is added to the screen 73. Since the candidate for the second image is the captured image 91(C), the seat image 93 is displayed in a displayed state in which the center of the first row of the rear seats is distinguishable from the other seats.

With a counterclockwise-direction slide on the screen 111, the captured images 91 move in the counterclockwise direction. By this movement, the captured image 91(B) disappears from the screen, and the captured image 91(E) appears next to the captured image 91(D), resulting in a screen 112. In the screen 112, since the candidate for the second image is the captured image 91(D), the seat image 93 is displayed in a display state in which the right side of the first row of the rear seat is distinguishable from the other seats.

With a counterclockwise-direction slide, the captured images 91 move in the order of B→C→D→E→F→G→B. With a clockwise-direction slide, the captured images 91 move in the order of G→F→E→D→C→B→G. The reason why A is not included is that the content is originally displayed on the touch panel display 50 and thus is not to be transferred and shared by the capturing.

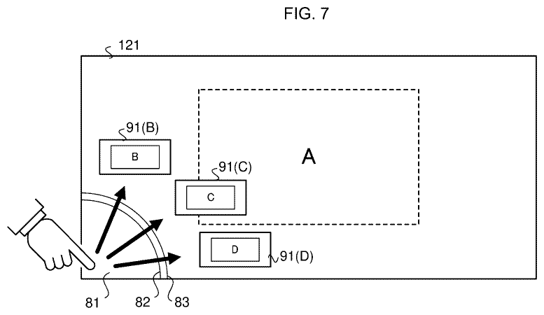

FIG. 7 is a modification of the method of selecting the second image. In the screen 121 of FIG. 7, a captured image located on an extension line of the slide operation is selected as the second image. To be specific, when the second gesture is detected in the FIG. 81, the display control unit 42c determines, as the second image, the captured image displayed in the traveling direction of the second gesture. When the length from the center of the circle sharing the circumference with the arc to the end point of the second gesture is equal to or less than a first length, the display control unit 42c selects the second mode. In contrast, when the distance from the center of the circle to the end point of the second gesture is equal to or greater than a second distance that is longer than the first distance, the first mode is selected. The first distance may be larger than the diameter of the arc 82 and smaller than the diameter of the arc 83. In this case, the second mode is selected when the slide operation stops near the arc 82, whereas the first mode is selected when the slide operation reaches the arc 83. Alternatively, the second mode may be selected when the finger is released at the arc 82, whereas the first mode may be selected when the finger is released at the arc 83.

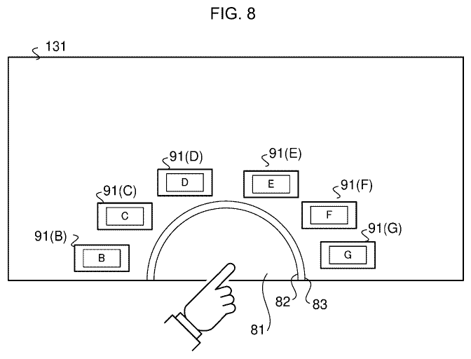

FIG. 8 is a modification showing a case where the first gesture is started from a side of the touch panel display 50. In a screen 131 of FIG. 8, a semicircular FIG. 81 is displayed around the operation start point, and the captured images 91(B) to 91(G) are arranged around the semicircular FIG. 81. In this manner, a circular figure may be displayed with the operation start point being the center.

As described above, the information processing device 40 capable of controlling content being displayed by a plurality of display devices 60 includes: the touch panel display 50; the gesture detection unit 42a that detects a gesture on the touch panel display 50; the communication unit 41 that communicates with the plurality of display devices 60; the selection screen display unit 42b that acquires a plurality of captured images of the contents when a first gesture is detected and that displays, on the touch panel, a selection screen for displaying the plurality of captured images around a figure displayed at a position including a start point of the first gesture; the display control unit 42c that determines, based on a second gesture, a second image to be displayed on the touch panel from among the plurality of captured images, selects one of a first mode for displaying the second image on the touch panel in a full-screen manner and a second mode for displaying the second image in a window displayed on the touch panel, and displays the second image in the selected mode; and the transmission unit 42d that transmits, to a display device of a capture destination, an operation command based on a third gesture when the third gesture on the second image is detected.

According to this configuration and operation, improved operability can be provided for an information processing device which is a sync device to which a plurality of source devices are connected.

The figure has an arc portion, and the plurality of captured images displayed around the figure move on the selection screen based on a gesture of sliding along the arc.

According to this configuration and the operation, it is possible to intuitively and easily select a plurality of source devices.

In addition, when the second gesture is detected outside the figure, the information processing device 40 determines, as the second image, the captured image displayed at a predetermined position. Then, the information processing device 40 selects the second mode when the amount of movement of the second gesture is less than the first amount of movement; but selects the first mode when the amount of movement of the second gesture is equal to or greater than the first amount of movement.

According to this configuration and the operation, the display state can be selected by a simple operation.

In addition, when the second gesture is detected in the figure, the information processing device 40 determines, as the second image, the captured image displayed in the traveling direction of the second gesture; when the distance from the center of the circle sharing the circumference with the arc to the end point of the second gesture is equal to or less than a first distance, the information processing device 40 selects the second mode; and when the distance from the center of the circle to the end point of the second gesture is equal to or greater than a second distance that is longer than the first distance, the information processing device 40 selects the first mode.

According to this configuration and the operation, the display state can be selected by a simple operation.

Note that the present invention is not limited to the above-mentioned embodiment and includes various modifications. For example, while the above-mentioned embodiment has been described in detail in order to describe the present invention in an easy-to-understand manner, the present invention is not necessarily limited to those with all the described configurations. Moreover, not only the deletion of such configurations, but also the replacement or addition of configurations is possible.

For example, in the present embodiment, the configuration in which the display device 60 installed in the vehicle 30 is used as the source device has been described as an example, but a smartphone or a tablet terminal carried by the occupant can be included in the possible source devices. In addition, in the present embodiment, a fan-shaped figure is illustrated as an example, but a figure having any shape may be used. In addition, in the present embodiment, the information processing device 40 acquires the captured images of the contents from the display devices 60 and generates the selection screen. As long as the information processing device, however, is configured to generate and provide image data for the display devices, the information processing device may generate the selection screen using the image data generated for the display devices.

### DESCRIPTION OF REFERENCE NUMERALS

30: Vehicle; 31: Network; 40: Information processing device; 41: Communication unit; 42: Processing unit; 42a: Gesture detection unit; 42b: Selection screen display unit; 42c: Display control unit; 42d: Transmission unit; 43: Display interface unit; 50: Touch panel display; 60: Display device; 61: Communication unit; 62: Control unit; 63: Touch panel display; 91: Captured image; 92: Window; 93: Seat image

1. An information processing device capable of controlling contents being displayed respectively on a plurality of display devices, the information processing device comprising:
a touch panel;
a gesture detection unit configured to detect a gesture on the touch panel;
a communication unit configured to communicate with the plurality of display devices;
a selection screen display unit configured to acquire, when a first gesture is detected, a plurality of captured images of the contents and to display, on the touch panel, a selection screen that displays the plurality of captured images around a figure displayed at a position including a start point of the first gesture;
a display control unit configured to determine, based on a second gesture, a second image to be displayed on the touch panel from among the plurality of captured images, to select one of a first mode in which the second image is displayed on the touch panel in full screen and a second mode in which the second image is displayed in a window displayed on the touch panel, and to display the second image in the selected mode; and
a transmission unit configured to transmit, when a third gesture on the second image is detected, an operation command based on the third gesture to a display device of a capture destination.

2. The information processing device according to claim 1, wherein:
the figure has an arc portion; and
on the selection screen, the plurality of captured images displayed around the figure are moved based on a gesture of sliding along the arc portion.

3. The information processing device according to claim 1, wherein:
when the second gesture is detected outside the figure, the captured image displayed at a predetermined position is determined as the second image, and
when the amount of movement of the second gesture is less than a first amount of movement, the second mode is selected whereas when the amount of movement of the second gesture is equal to or greater than the first amount of movement, the first mode is selected.

4. The information processing device according to claim 2, wherein:
when the second gesture is detected in the figure, the captured image displayed in a traveling direction of the second gesture is determined as the second image;
when a distance from a center of a circle sharing a circumference with the arc to an end point of the second gesture is equal to or less than a first distance, the second mode is selected; and
when a distance from the center of the circle to the end point of the second gesture is equal to or greater than a second distance that is longer than the first distance, the first mode is selected.

5. A display control method for controlling contents being displayed by a plurality of display devices, the display control method comprising the steps of:
a gesture detection step of detecting a gesture on a predetermined touch panel;
a selection screen display step of, when a first gesture is detected, acquiring a plurality of captured images of the contents and displaying, on the touch panel, a selection screen for displaying the plurality of captured images around a figure displayed at a position including a start point of the first gesture;
a display control step of determining, based on a second gesture, a second image to be displayed on the touch panel from among the plurality of captured images, selecting one of a first mode in which the second image is displayed on the touch panel in full screen and a second mode in which the second image is displayed in a window displayed on the touch panel, and displaying the second image in the selected mode; and
a transmission step of transmitting, when a third gesture on the second image is detected, an operation command based on the third gesture to a display device of a capture destination.

6. The display control method according to claim 5, wherein:
the figure has an arc portion; and
on the selection screen, the plurality of captured images displayed around the figure are moved based on a gesture of sliding along the arc portion.

7. The display control method according to claim 5, wherein
when the second gesture is detected outside the figure, the captured image displayed at a predetermined position is determined as the second image, and
when the amount of movement of the second gesture is less than a first amount of movement, the second mode is selected whereas when the amount of movement of the second gesture is equal to or greater than the first amount of movement, the first mode is selected.

8. The display control method according to claim 6, wherein:
when the second gesture is detected in the figure, the captured image displayed in a traveling direction of the second gesture is determined as the second image;
when a distance from a center of a circle sharing a circumference with the arc portion to an end point of the second gesture is equal to or less than a first distance, the second mode is selected; and
when a distance from the center of the circle to the end point of the second gesture is equal to or greater than a second distance that is longer than the first distance, the first mode is selected.
